(19) United States
(12) Patent Application Publication
(10) Pub. No.: US 2017/0109810 A1
(43) Pub. Date: Apr. 20, 2017

(54) Wheres My Stuff

(71) Applicant: William Joseph Ditchkus, Toms River, NJ (US)

(72) Inventor: William Joseph Ditchkus, Toms River, NJ (US)

(21) Appl. No.: 14/885,323

(22) Filed: Oct. 16, 2015

(51) Int. Cl. G06Q 30/06

(52) U.S. Cl. CPC G06Q 30/0639; G06Q 30/0625; G06Q 30/0633

(57) ABSTRACT

A smart phone shopping application, particularly for locating the products in a store, such a supermarket or a department store is disclosed. The application displays the floor plan of the store indicating the aisles and shelves for the products through GPS. The customers allows to enter their shopping list with multiple products in it, apply filters to locate the product and browse the inventory of the stores to check the availability and other information like manufacturing and expiry dates, weight, batch, price, etc. The application is accessible in any electronic device, preferably a mobile phone of the customer, and this is compatible and convenient to use.

### CROSS REFERENCE TO RELATED APPLICATION

Not Applicable

### FEDERALLY SPONSORED RESEARCH AND DEVELOPMENT

Not Applicable

### MICROFICHE APPENDIX

Not Applicable

### BACKGROUND OF THE INVENTION

(1) Field of Invention

The present invention relates to the field of mobile applications and, more particularly, to a mobile phone application providing a system and method for locating the products in a store, such a supermarket or a department store.

(2) Background of Invention

Presently, when a consumer is shopping at a store, he or she needs to walk up and down aisles to find different products. Typically, the consumer locates one of the service employees or personnel in the store to find out where a product can be found.

For convenience, floor map for the stores are available for guiding the customers. Conventional store mapping or product locating systems typically show a floor plan for a floor of a store in which various store departments or aisles are depicted, and various product types or groupings are labeled as sections on the floor plan. Other product locating systems include those that provide a display board index to the aisle numbers of various product types or groupings. With these conventional store mapping and product locating systems, customers often have difficulty locating a product if they search for it by a name or phrase not used in the store floor plan maps or product indexes. Also, within any given product department or aisle, there may be many brands, styles and sizes of products of similar type being stocked within a large area or shelf space, and it may be difficult for a customer to pinpoint the exact location of the product they are searching for, thereby requiring them to hunt up and down the aisle.

Known in the art are methods and systems within the stores to locate the desired items. U.S. Patent Application No. 20140005155, issued Jan. 2, 2014, provides an instant facility/store floor plan and mobile marketing map to users of mobile devices having access to the Internet. This invention provides a unique program and system that will aid: customers using smart phones or mobile devices in facilities and stores to quickly locate articles they desire without the help of a present employee, for example a sales clerk, along with the is added benefit of receiving advertising and coupons to related products.

Another U.S. Patent Application No. 29140297420, issued Oct. 2, 2014 to Kyle Patel, discloses an interactive shopping system for use with mobile computing devices. A computer-implemented system links product information, location and sales information with mobile computing devices such as a smart-phone of a shopper. The shopper's smart-phone displays a route to the products in which he/she is interested by input to the application on his or her phone or mobile computing device.

Accordingly, a need remains for a system and method to assist the customers in locating the desired product within the stores.

As such, it may be appreciated that there continues to be a need for a new and improved smart phone application as set forth by the instant invention which addresses the problems of ease of use as well as effectiveness in construction in providing the assistance to the customers and in this respect, the present invention substantially fulfills this need.

### BRIEF SUMMARY OF THE INVENTION

In view of the foregoing disadvantages inherent in the known types of shopping websites and mobile applications now present in the prior art, the present invention provides smart phone application wherein the same provides for a shopping related app, particularly for locating the desired products in the stores and use on process of various components employed in the procedure. As such, the general purpose of the present invention, which will be described subsequently in greater detail, is to provide a new and improved smart phone application which has all the advantages of the prior art and none of the disadvantages.

Accordingly, it is a primary aspect of the present invention to provide a smart phone application which tends to display the location of the products within the stores.

In another aspect, the present invention provides a smart phone application that utilizes the GPS system for locating the products and provides the floor plan of the store.

it is another aspect of the present invention where the customers get information on the availability of the products in the store through this app. For the purpose, this, application provides the store inventory and respective stocking shelves.

In yet another aspect, the present invention provides a smart phone application that provides the related description of the products, like availability, price, expiry date, etc.

Further aspect of the present smart phone application provides the various and filters to sort the products in easy accessible way to shop.

In another aspect, the customers can easily upload the shopping list in the smart phone application and thereby the customers receive the aisles each product is on.

It is still another aspect of the present invention to provide a new and improved smart phone application which may be easily and efficiently provides a platform to locate and shop the products within the store.

It is a further aspect of the present invention to provide a new and improved smart phone application which is very reliable to use and is compatible with most online shopping provider retail or departmental stores.

Other aspects of the present invention will become apparent from time to time throughout the specification as hereinafter related.

In this respect, before explaining at least one embodiment of the invention in detail, it is to be understood that the invention is not limited in its application to the details of construction and to the arrangements of the components set forth in the following description. The invention is capable of other embodiments and of being practiced and carried out in various ways. Also, it is to be understood that the phraseology and terminology employed herein are for the purpose of description and should not be regarded as limiting.

These together with other aspects of the invention, along with the various features of novelty which characterize the invention, are pointed out with particularity in the disclosure. For a better understanding of the invention, its operating advantages and the specific objects attained by its uses, reference should be had to the accompanying descriptive matter in which there are illustrated preferred embodiments of the invention.

### DETAIL DESCRIPTION OF THE INVENTION

Various aspects of the illustrative embodiments will be described using the terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

The description that follows includes exemplary devices, methods, memory, systems, techniques, instruction sequences and computer program products that embody techniques of the present inventive subject matter. However, it should be understood that the described embodiments may be practiced without these specific details. Well-known instruction instances, protocols, structures and techniques have not been shown in detail in order not to obfuscate the description.

The inventive subject matter includes devices, methods, memory, and systems. utilizing mobile technology. The technology can be used in conjunction with mobile devices, such as but limited to, the mobile phone devices.

In some preferred embodiments, the systems, methods and/or techniques of a shopping related mobile application are disclosed. A shopping portal, application may reside and execute on an electronic device e.g., a mobile phone device of the customer. The application provides the user accessibility to locate the items within the stores, such a supermarket or a department store. The customer inputs the products he or she wishes to s see into the application on his or her mobile phone device. The customer's smart-phone displays a route to the products. After the shopper is mapped to the products in the most efficient order, specific product and related information are downloaded to the customer's phone or device, leading to an efficient and successful shopping event.

In one embodiment, the present invention discloses a system and method which allows a customer to search for a particular store product and be provided, as output, an aisle number/designator which will immediately direct the customer to the appropriate store location.

Accordingly, the invention comprehends an electronic shopping assistance system communicating between a store database and a customer assistance terminal for providing a product aisle location for a consumer. The shopping assistance terminal operates as a product locator search terminal. Product locations are maintained in the store database, and as a search product is keyed into the customer assistance terminal, the item's location is displayed on the display screen of the customer's mobile phone device.

Further, disclosed is a system and method for assisting, a shopper, comprising the steps of networking a system, wherein the application system includes a store database for tracking inventory as part of an existing inventory management system used by a store; allowing a customer to input product information into the application, wherein the product information includes a name of a product; outputting to the customer, via the application system, an aisle number associated with the product such that the customer can proceed directly to an aisle at which the product is stored. The method further comprises the step of filtering data from the store database such that the only of the data presented as the product location information is the name and the aisle number.

In one embodiment, the application further allows the customers tea input the shopping list comprising multiple products in one time and thereby providing an aisle location of each product to the consumer. Additionally, the system and method further comprises the step of sorting the product location information when multiple of the products are inputted, wherein the product location information is outputted in an order allowing the customer to proceed sequentially within the store.

Further, in one embodiment, the application provides the related information of the products, such as availability, manufacturing date, expiry date, weight, batch, price, ingredients, etc. to sort the desired products accordingly in more accessible way. The mobile application may also be utilized to obtain information such as product reviews and ratings concerning products that are of interest to the customers.

In an embodiment, a mobile application is provided to the customers for use to facilitate locating products in a store by using, for example enhanced global positioning satellite (GPS) technology to provide the exact location of the products and thereby providing the floor plan of the store.

It is to be understood that the above description is intended to be illustrative, and not restrictive. For example, the above-discussed embodiments may be used in combination with each other. Many other embodiments will be apparent to those of skill in the art upon reviewing the above description.

Although specific embodiments have been illustrated and described herein it will be appreciated by those of ordinary skill in the art that any arrangement, which is calculated to achieve the same purpose, may be substituted for the specific embodiment shown. This application is intended to cover any adaptations or variations of the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. An application for providing a shopping portal service, particularly for locating the products in a store, wherein said application is accessible upon an electronic device.

2. An application as claim d in claim 1, wherein said electronic device is a mobile phone device.

3. An application as claimed in claim 1, wherein said application locates the exact location of the product in a store, providing the related information of aisles and store shelves.

4. An application as claimed in claim 1, wherein said application provides the floor plan of the store displays a route to the products.

5. An application as claimed in claim 1, wherein said application provides the floor plan of the store displays a route to the products via GPS technology.

6. An application as claimed in claim 1, wherein said application provides the inventory of the products sold in the store.

7. An application as claimed in claim 1, wherein said application provides the tabs and filters to browse and locate the desired products.

8. An application as claimed in claim 1, wherein said application provides the related description of the products including the manufacturing and expiry dates, weight, batch, price and like information.

9. An application as claimed in claim 1, wherein said application allows the customers to input the shopping list comprising multiple products in one time and thereby providing an aisle location of each product to the consumer.

10. An application as claimed in claim 1, wherein said application provides an ease to locate the products in store, leading to an efficient and successful shopping event.
